(19) United States
(12) Patent Application Publication
(10) Pub. No.: US 2023/0074854 A1
(43) Pub. Date: Mar. 9, 2023

(54) INFORMATION PROCESSING APPARATUS AND MANAGEMENT METHOD

(71) Applicant: FUJITSU LIMITED, Kawasaki-shi (JP)

(72) Inventors: Hiroshi Endo, Fuji (JP); Hiroyoshi Kodama, Isehara (JP); Takahide Yoshikawa, Kawasaki (JP)

(73) Assignee: FUJITSU LIMITED, Kawasaki-shi (JP)

(21) Appl. No.: 17/834,979

(22) Filed: Jun. 8, 2022

(30) Foreign Application Priority Data
Aug. 12, 2021 (JP) 2021-131775

(51) Int. Cl. G06F 9/50; G06F 1/329

(52) U.S. Cl. CPC G06F 9/5094; G06F 1/329; G06F 2209/509

(57) ABSTRACT

A non-transitory computer-readable recording medium stores a program that causes a computer to execute a process that includes receiving load arrangement of jobs in a case where a compute server mounted in a compute rack in a server room executes the jobs, the server room being a room where the compute rack in which the compute server is mounted and a storage rack in which a storage is mounted are arranged, and estimating a time at which a predetermined job of the compute server is to be offloaded to the storage that generates less heat than the compute server and estimating setting temperature and an air volume of an air conditioner, based on the load arrangement and time-series data of temperature and power of the server room, such that the power of the server room is reduced within limitation conditions of the compute server, the storage, and the air conditioner.

### CROSS-REFERENCE TO RELATED APPLICATION

This application is based upon and claims the benefit of priority of the prior Japanese Patent Application No. 2021-131775, filed on Aug. 12, 2021, the entire contents of which are incorporated herein by reference.

### FIELD

The embodiment discussed herein is related to an information processing apparatus and a management method.

### BACKGROUND

Racks (storage racks) in which storage servers are mounted and racks (compute racks) in which compute servers are mounted are present in a mixed manner in a data center that provides a housing service, a supercomputer room for a high-performance computer (HPC), and the like. An air conditioning controller controls an air conditioner based on information of installed temperature sensors and power sensors and sensors in server devices. The air conditioner cools each rack while changing setting temperature and an air volume.

Regarding air conditioning control of a data center or a server room, there is disclosed a technique in which an air conditioning system allocates some of loads of an information processing apparatus to another information processing apparatus and controls air conditioning.

Japanese Laid-open Patent Publication No. 2012-149839, Japanese Laid-open Patent Publication No. 2009-293851, and Japanese Laid-open Patent Publication No. 2009-217500 are disclosed as related art.

### SUMMARY

According to an aspect of the embodiment, a non-transitory computer-readable recording medium stores a management program that causes a computer to execute a process, the process includes receiving load arrangement of jobs in a case where a compute server mounted in a compute rack in a server room executes the jobs, the server room being a room where the compute rack in which the compute server is mounted and a storage rack in which a storage is mounted are arranged, and estimating a time at which a predetermined job of the compute server is to be offloaded to the storage that generates less heat than the compute server and estimating setting temperature and an air volume of an air conditioner, based on the received load arrangement of the jobs and time-series data of temperature and power of the server room, such that the power of the server room is reduced within limitation conditions of the compute server, the storage, and the air conditioner.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of control of cooling a server room including compute racks and storage racks;

FIG. 2 is a diagram illustrating an example of a first management process according to an embodiment;

FIG. 3 is a diagram illustrating an example of a second management process according to the embodiment;

FIG. 4 is a diagram illustrating an example of a functional configuration of a system including a management apparatus according to the embodiment;

FIG. 5 is a diagram illustrating an example of a flowchart of a data collection process according to the embodiment;

FIG. 6 is a diagram illustrating an example of a flowchart of a scheduler process according to the embodiment;

FIG. 7A is a diagram illustrating an example of a flowchart of the first management process by the management apparatus according to the embodiment;

FIG. 7B is a diagram illustrating an example of a flowchart of the second management process by the management apparatus according to the embodiment;

FIGS. 8A and 8B are diagrams illustrating effects of the processes by the management apparatus according to the embodiment;

FIG. 9 is a diagram illustrating a hardware configuration example of the management apparatus according to the embodiment;

FIG. 10 is a diagram illustrating a reference example of cooling of a server room including compute racks and storage racks; and

FIGS. 11A and 11B are diagrams illustrating reference examples of load distribution.

### DESCRIPTION OF EMBODIMENT

The aforementioned technique has a problem of an air conditioner being controlled such that the setting temperature and air volume of air conditioning are excessive. For example, the storage rack and the compute rack have different temperature limitations. Although the storage server mounted in the storage rack has to be supplied with low-temperature cold air, the storage server generates less heat than the compute server and may be thus supplied with a low volume of air while being designed to cope with low temperature. Meanwhile, the compute server mounted in the compute rack generates more heat than the storage server, and load change therein is greater. The compute server has to be designed to cope with low temperature to high temperature and has to be supplied with low volume to high volume of air depending on the load. Accordingly, the air conditioning controller sets the setting temperature to lower temperature and the air volume to a higher air volume in the server room or the data center due to different limitations of temperature and the like of the storage server and the compute server. That is, the air conditioner excessively cools the storage rack to meet the desired temperature and air volume for the compute server in the compute rack. Thus, the setting temperature and air volume of air conditioning by the air conditioner are controlled to excessive levels.

An embodiment of an information processing apparatus and a management method according to the present disclosure will be described below in detail with reference to the drawings. This disclosure is not limited by the embodiment.

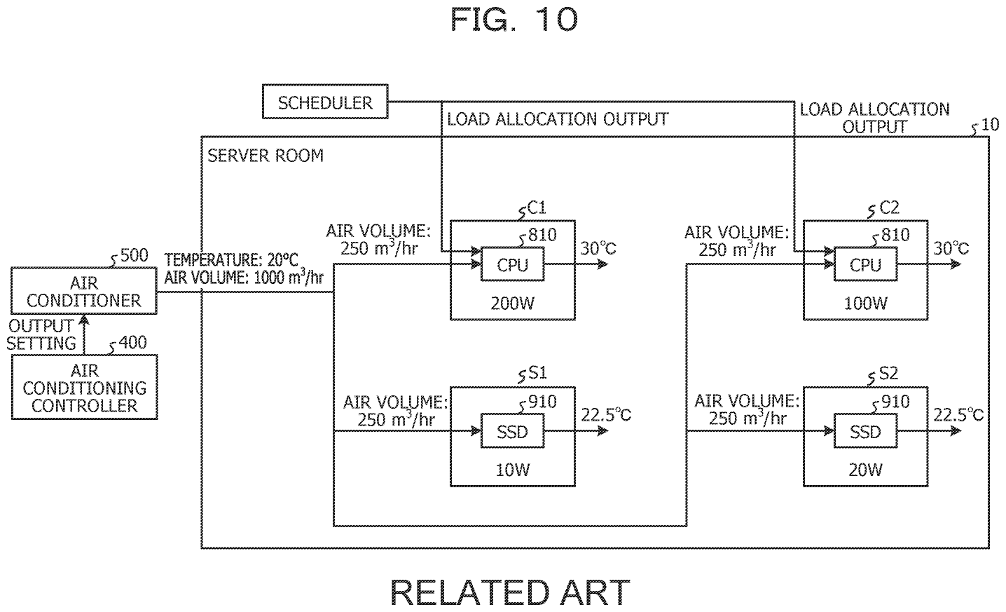

First, a reference example of cooling of a server room including compute racks and storage racks will be described with reference to FIG. 10. FIG. 10 is a diagram illustrating the reference example of cooling of the server room including the compute racks and the storage racks. The server room may be a data center.

As illustrated in FIG. 10, compute racks C1 and C2 and storage racks S1 and S2 are arranged in a server room 10. Not-illustrated compute servers are mounted in the compute racks C1 and C2, and central processing units (CPUs) 810 of the compute servers execute jobs that are loads, based on load allocation (scheduling) by a scheduler. Solid-state drives (SSDs) 910 representing storages are mounted in the storage racks S1 and S2.

The storage racks S1 and S2 and the compute racks C1 and C2 have different limitations. Although the storage mounted in each storage racks has to be supplied with low-temperature cold air, the storage generates less heat than the compute server and may be thus supplied with a low volume of air while being designed to cope with low temperature. Meanwhile, the compute server mounted in each compute rack generates more heat than the storage and the load change therein is greater. The compute server has to be designed to cope with low temperature to high temperature and has to be supplied with low volume to high volume of air depending on the load. Accordingly, an air conditioning controller 400 that controls an air conditioner 500 sets the setting temperature to lower temperature and the air volume to a higher air volume in the server room 10 due to different limitations of temperature and the like of the storage server and the compute server. That is, the air conditioning controller 400 causes the air conditioner 500 to excessively cool the storage racks to meet the temperature and air volume desirable for the compute servers in the compute racks C1 and C2. Thus, the air conditioner 500 is controlled such that the setting temperature and air volume of air conditioning are excessive.

In this example, in the compute rack C1, the CPU 810 of the compute server consumes power of 200 watts (W) according to the load. In the compute rack C2, the CPU 810 of the compute server consumes power of 100 W according to the load. Meanwhile, in the storage rack S1, the SSD 910 consumes power of 10 W. In the storage rack S2, the SSD 910 consumes power of 20 W. The air conditioner 500 cools the server room 10 at the setting temperature indicating 20° C. and the air volume indicating 1000 m³/hr, due to different limitations in the respective racks. That is, the air conditioning controller 400 causes the air conditioner 500 to excessively cool the storage racks S1 and S2 to meet the temperature limitations of the compute servers in the compute racks C1 and C2. Thus, the temperature and air volume of air conditioning by the air conditioner 500 are controlled to excessive levels.

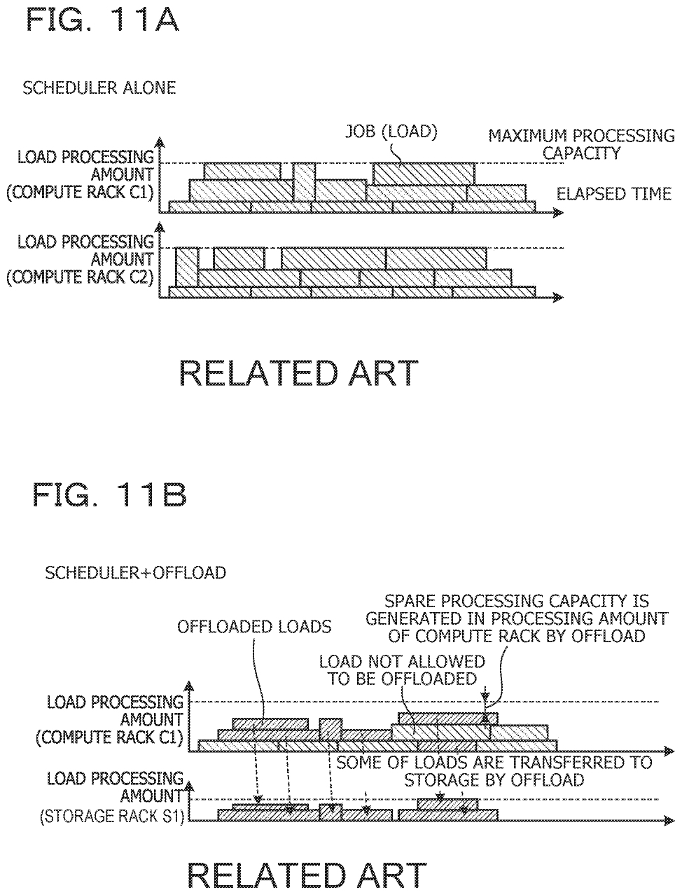

Reference examples of load distribution in the compute racks and the storage racks will be described by using FIGS. 11A and 11B with reference to FIG. 10. FIGS. 11A and 11B are diagrams illustrating the reference examples of load distribution. FIG. 11A illustrates a result in which the scheduler alone outputs the load allocation to each of the compute racks C1 and C2. The scheduler packs jobs (loads), varying in load size and execution time, into each of the compute racks C1 and C2 within a range of the maximum processing capacity of each compute rack. The greater the load is, the more the heat generated by the CPU 810 of the compute server mounted in each of the compute racks C1 and C2 is. Accordingly, the air conditioning controller 400 causes the air conditioner 500 to excessively cool the storage racks S1 and S2 to meet the limitations of temperature and the like of the compute servers in the compute racks C1 and C2. Thus, the temperature and air volume of air conditioning by the air conditioner 500 are controlled to excessive levels.

The storages mounted in the storage racks S1 and S2 include storages with an offload function. That is, there are storages that cover some of the loads of the CPU 810. There is known a system that uses a storage with the offload function as described above to balance loads by executing some of the loads, limited to loads allowed to be offloaded, in the storage mounted in the storage rack.

FIG. 11B illustrates a result in which a system having the scheduler and the offload function outputs the load allocation to the compute racks C1 and C2 and the storage racks S1 and S2. For convenience of description, only the compute rack C1 and the storage rack S1 are illustrated in FIG. 11B. The scheduler packs jobs (loads), varying in load size and execution time, into the compute rack C1 within a range of the maximum processing capacity of each compute rack C1. The system offloads some of the loads, limited to loads allowed to be offloaded, to the storage rack S1. Some of the loads are transferred to the storage mounted in the storage rack S1 by the offload and are executed in the storage. The heat generated by the CPU 810 of the compute server mounted in the compute rack C1 thus decreases by an amount corresponding to the balancing of loads. However, since the air conditioning controller 400 adjusts the temperature and air volume of air conditioning according to the limitations of the temperature and the like of the compute server in the compute rack C1 and the storage in the storage rack S1, the air conditioner 500 still excessively cools the server room 10. Thus, the temperature and air volume of air conditioning by the air conditioner 500 are controlled to excessive levels.

Accordingly, in the following embodiment, description will be given of a system capable of reducing temperature unevenness between racks and suppressing temperature and air volume of air conditioning.

[Example of Control of Cooling Server Room]

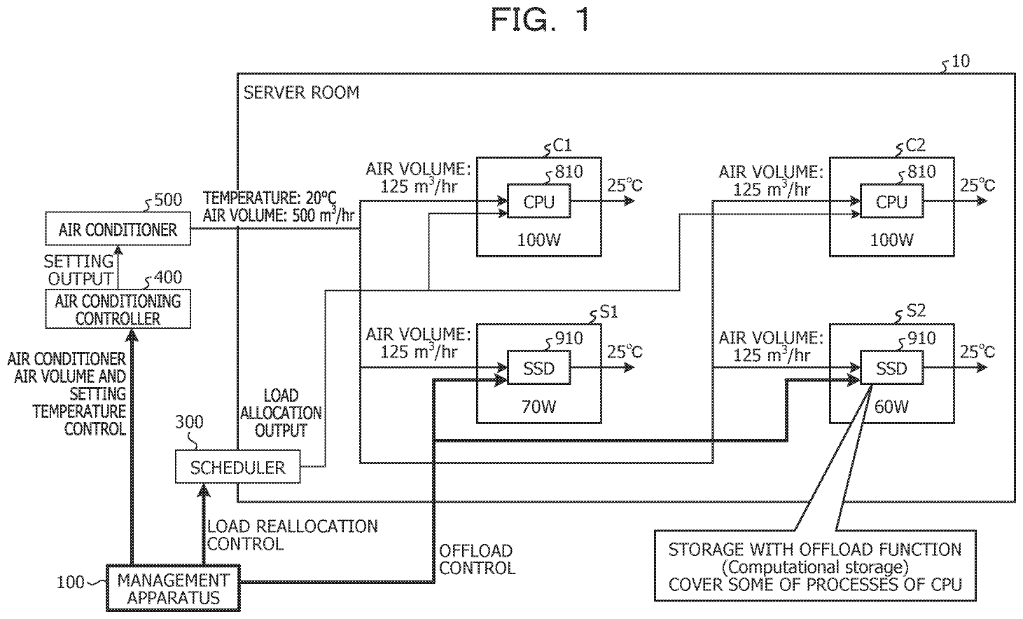

FIG. 1 is a diagram illustrating an example of control of cooling a server room including compute racks and storage racks. As illustrated in FIG. 1, the compute racks C1 and C2 and the storage racks S1 and S2 are arranged in the server room 10. Not-illustrated compute servers are mounted in the compute racks C1 and C2, and CPUs 810 of the compute servers execute jobs that are loads based on load allocation (scheduling) by a scheduler 300. SSDs 910 representing storages are mounted in the storage racks S1 and S2, and have the offload function. The SSDs 910 are, for example, SSDs incorporating field-programmable gate arrays (FPGAs). For example, the SSDs 910 are capable of covering some of the loads of the CPUs 810 by using the incorporated FPGAs. Hereinafter, the SSDs 910 mean storages having the offload function and are assumed to be SSDs incorporating FPGAs.

A management apparatus 100 controls the scheduler 300, an air conditioning controller 400, and an air conditioner 500 to adjust air conditioning of the server room 10. The management apparatus 100 receives load arrangement related to loads to be inputted into the CPUs 810 from the scheduler 300. The load arrangement described herein means, for example, arrangement indicating time and location (CPU 810) where each job that is the load is to be executed. Based on the received load arrangement and time-series data of each of temperature and power in the server room 10, the management apparatus 100 determines setting temperature and an air volume of air conditioning, and determines new load arrangement (load distribution) including whether or not some of the loads in the load arrangement are to be offloaded to the SSDs 910. The management apparatus 100 outputs the determined setting temperature and air volume of air conditioning to the air conditioning controller 400, and the air conditioning controller 400 outputs the setting temperature and air volume to the air conditioner 500. The management apparatus 100 outputs the loads determined to be offloaded to the target SSD 910 by offload control. The management apparatus 100 outputs the remaining load arrangement (load distribution) to the target CPU 810. The setting temperature and air volume of air conditioning and the new load arrangement (load distribution) are determined by using, for example, a temperature estimation model, a power estimation model, and a power optimization model to be described later.

The management apparatus 100 may thereby reduce the temperature unevenness between the racks and suppress the temperature and air volume of air conditioning. In this example, in the compute rack C1, the CPU 810 of the compute server consumes power of 100 watts (W) according to the load. In the compute rack C2, the CPU 810 of the compute server consumes power of 100 W according to the load. Meanwhile, in the storage rack S1, the SSD 910 consumes power of 70 W. In the storage rack S2, the SSD 910 consumes power of 60 W. The air conditioner 500 cools the server room 10 at the setting temperature indicating 20° C. and the air volume indicating 500 m³/hr in consideration of the different limitations of the respective racks. In the CPUs 810 and the SSDs 910, the temperature becomes 25° C. due to heat generated by the processes, and the temperature unevenness between the racks is reduced. The air volume of air conditioning may be reduced from that in the reference example of FIG. 10.

[Example of First Management Process]

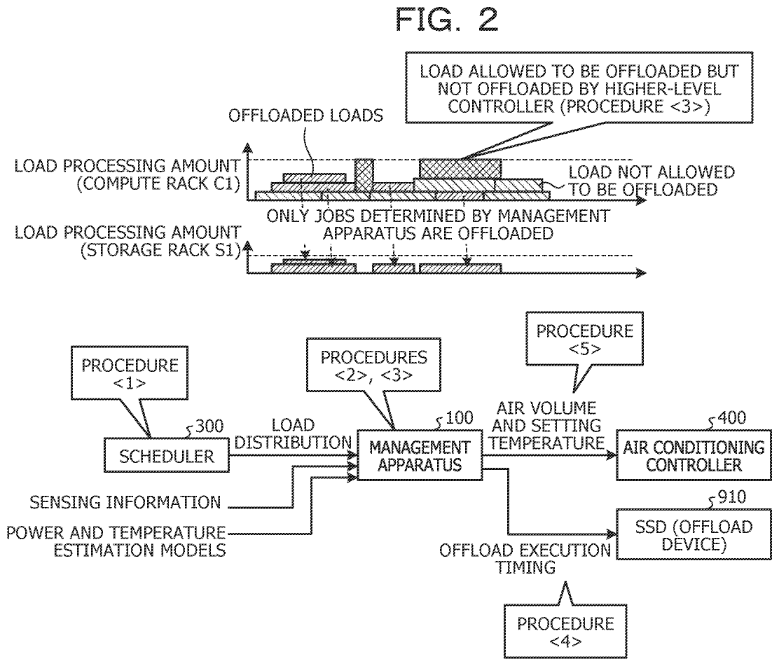

FIG. 2 is a diagram illustrating an example of a first management process according to the embodiment. As illustrated in FIG. 2, the scheduler 300 determines the load arrangement (load distribution) to be executed in the CPU 810 of the compute server mounted in each of the compute racks C1 and C2 (<1>). The scheduler 300 may be software or hardware that manages any schedule, and is sufficient as long as it is capable of determining the load arrangement to be executed in the CPU 810.

The management apparatus 100 receives the load distribution and estimates temperature distribution and power distribution of the server room 10 in the case of the determined load arrangement based on the temperature estimation model and the power estimation model of the server room 10 (<2>). The management apparatus 100 estimates new load distribution including an offload execution timing and control amounts (setting temperature and air volume) of air conditioning, based on the temperature distribution, the power distribution, and the power optimization model, such that the power of the server room 10 is minimized within limitation conditions (<3>).

The management apparatus 100 outputs information indicating execution of offload for a load of the offload execution timing in the new load distribution, to the SSD 910 (<4>). The management apparatus 100 outputs the load distribution excluding the load of the offload execution timing in the new load distribution, to the CPU 810 via the scheduler 300. The management apparatus 100 outputs the control amount (setting temperature and air volume) of air conditioning estimated in <3>, to the air conditioning controller 400 (<5>).

The load arrangement (load distribution) determined by the scheduler 300 is illustrated for the CPU 810 of the compute server mounted in the compute rack C1. Only the loads (jobs) determined by the management apparatus 100 in the load arrangement (load distribution) determined by the scheduler 300 are offloaded to the SSD 910 mounted in the storage rack S1. Loads (jobs) that are allowed to be offloaded but are not determined by the management apparatus 100 are not offloaded.

The temperature estimation model, the power estimation model, and the power optimization model used in <2> and <3> will be described.

The temperature estimation model is expressed by the following formula (1).

$$= ( {a}_{1 , i - n} {T}_{1 , t - n} + … + {a}_{1 , t} {T}_{1 , t} ) + … + ( {a}_{i , t - n} {T}_{i , t - n} + … + {a}_{i , t} {T}_{i , t} ) + ( {b}_{1 , t - n} {P}_{1 , t - n} + … + {b}_{1 , t} {P}_{1 , t} ) + … + ( {b}_{j , t - n} {P}_{j , t - n} + … + {b}_{j , t} {P}_{j , t} ) + ( {c}_{1 , t - n} {W}_{1 , t - n} + … + {c}_{1 , t} {W}_{1 , t} ) + … + ( {c}_{k , t - n} {W}_{k , t - n} + … + {c}_{k , t} {W}_{k , t} ) + ( {d}_{1 , t - n} {S}_{1 , t - n} + … + {d}_{1 , t} {S}_{1 , t} ) + … + ( {d}_{i , t - n} {S}_{i , t - n} + … + {d}_{i , t} {S}_{i , t} ) + ( {e}_{1 , t - n} {F}_{1 , t - n} + … + {e}_{1 , t} {F}_{1 , t} ) + … + ( {e}_{i , t - n} {F}_{i , t - n} + … + {e}_{i , t} {F}_{i , t} ) \qquad ( 1 )$$

Pieces of temperature data measured by i indoor temperature sensors in the server room 10, pieces of power data measured by j device power sensors, and load amounts to be inputted into the respective CPUs 810 and SSDs 910, are inputted into the temperature estimation model expressed by the formula (1). The number of steps for which the estimation is to be performed by using the temperature estimation model is determined based on the configuration of the server room 10 and the like. In this example, the temperature estimation model is a linear model for estimating temperature T in the next step. The temperature data T measured by each of the i indoor temperature sensors indicates a value of each of the indoor temperature sensors from a time point t−n to a time point t. The power data P measured by each of the j device power sensors indicates a value of each of the device power sensors from the time point t−n to the time point t. The total number of the compute servers and the storages is assumed to be j.

Here, the k pieces of the load amount data W from the time point t-n to the time point t are unknown data. The total number of the CPUs 810 and the SSDs 910 (FPGAs) capable of offload is assumed to be k. The l pieces of air conditioning setting temperature data S from the time point t−n to the time point t are unknown data. The l pieces of air conditioning air volume data F from the time point t−n to the time point t are unknown data. The total number of air conditioners is assumed to be l. Coefficients a, b, c, and d are determined respectively by model learning.

Since the power estimation model is a linear model similar to the formula (1), the formula of this model is omitted. In the power estimation model, the coefficients a, b, c, and d may be changed to those for power estimation. The coefficients a, b, c, and d are determined respectively by model learning.

The power optimization model is expressed by the following formula (2).

$${min}_{Server room power} = {\begin{matrix}Air conditioning power \\ ( models formed of temperature and power \\ estimation values )\end{matrix}}_{} + {Server and storage power}_{} \qquad ( 2 )$$

$$Limitation conditions : , … \leq {T}_{limit}$$

$$, … \leq {P}_{limit}$$

$${W}_{1 , t} , … {W}_{k , t} \leq {W}_{limit}$$

$${S}_{1 , t} , … {S}_{k , t} \leq {S}_{limit}$$

$${F}_{1 , t} , … {F}_{k , t} \leq {F}_{limit}$$

The power optimization model expressed by the formula (2) includes the temperature estimation model and the power estimation model. The load amount data W_{k,t} (k: 1 to k), the air conditioning setting temperature S_{l,t} (l: 1 to l), and the air conditioning air volume F_{l,t} (l: 1 to l) in the temperature estimation model and the power estimation model are unknown data. In the power optimization model, numerical values within the limitation conditions are assigned to the aforementioned unknown data to determine the load amount data W_{k,t} (k: 1 to k), the air conditioning setting temperature S_{l,t} (l: 1 to l), and the air conditioning air volume F_{l,t} (l: 1 to l) at which the power P_{all,t+1} of the server room 10 is minimized within the limitation conditions.

The limitation conditions include such conditions that estimated temperature data T_{i,t+1} (i: 1 to i) in each of the i indoor temperature sensors is within a temperature condition Tₗᵢₘᵢₜ of the server room 10 and the devices and that estimated power data P_{j,t+1} (j: 1 to j) in each of the j device power sensors is within a power condition Pₗᵢₘᵢₜ of the server room 10 and the devices. The limitation conditions also include such a condition that the load amount data W_{k,t} (k:1 to k) to be assigned to each of the k devices are within a device condition or a condition Wₗᵢₘᵢₜ specified by the scheduler 300. The limitation conditions also include such a condition that the setting temperature data S_{l,t} (l: 1 to l) and the air volume data F_{l,t} (l: 1 to l) of each of the l air conditionings are within device conditions Sₗᵢₘᵢₜ and Fₗᵢₘᵢₜ, respectively.

The management apparatus 100 receives the load distribution and estimates the power distribution and temperature distribution of the server room 10 in the case of the determined load arrangement based on the temperature estimation model (1) and the power estimation model of the server room 10. The management apparatus 100 estimates the new load distribution including the offload execution timing and the air conditioning control amounts (setting temperature and air volume), based on the power optimization model (2) in addition to the power distribution and temperature distribution, such that the power of the server room 10 is minimized within the limitation conditions.

The new load distribution including the offload execution timing may be estimated as expressed by the following formula (3). The formula (3) is a formula in the case where one compute server and one storage are installed in the server room 10.

$$\begin{matrix}= ( {a}_{1 , t - 2} {T}_{1 , t - 2} + {a}_{1 , t - 1} {T}_{1 , t - 1} + {a}_{1 , t} {T}_{1 , t} ) + & ( {a}_{2 , t - 2} {T}_{2 , t - 2} + {a}_{2 , t - 1} {T}_{2 , t - 1} + {a}_{2 , t} {T}_{2 , t} ) \\ + ( {b}_{1 , t - 2} {P}_{1 , t - 2} + {b}_{1 , t - 1} {P}_{1 , t - 1} + {b}_{1 , t} {P}_{1 , t} ) + & ( {b}_{2 , t - 2} {P}_{2 , t - 2} + {b}_{2 , t - 1} {P}_{2 , t - 1} + {b}_{2 , t} {P}_{2 , t} ) \\ + ( {c}_{1 , t - 2} {W}_{1 , t - 2} + {c}_{1 , t - 1} {W}_{1 , t - 1} + {c}_{1 , t} {W}_{1 , t} ) + & ( {c}_{2 , t - 2} {W}_{2 , t - 2} + {c}_{2 , t - 1} {W}_{2 , t - 1} + {c}_{2 , t} {W}_{2 , t} ) \\ + ( {d}_{1 , t - 2} {S}_{1 , t - 2} + {d}_{1 , t - 1} {S}_{1 , t - 1} + {d}_{1 , t} {S}_{1 , t} ) + & ( {d}_{2 , t - 2} {S}_{2 , t - 2} + {d}_{2 , t - 1} {S}_{2 , t - 1} + {d}_{2 , t} {S}_{2 , t} ) \\ {+ ( {e}_{1 , t - 2} {F}_{1 , t - 2} + {e}_{1 , t - 1} {F}_{1 , t - 1} + {e}_{1 , t} {F}_{1 , t} ) +}_{Temperature and load of server ( CPU )} & {( {e}_{2 , t - 2} {F}_{2 , t - 2} + {e}_{2 , t - 1} {F}_{2 , t - 1} + {e}_{2 , t} {F}_{2 , t} )}_{Temperature and load of storage ( FPGA )}\end{matrix} \qquad ( 3 )$$

$$Case where offload is performed : {W}_{2 , t} \neq 0$$

$$Case where no offload is performed : {W}_{2 , t} = 0$$

In the temperature estimation model expressed by the formula (3), the load data W and the setting temperature S and air volume F of air conditioning at the time point t are estimated by using the power optimization model. In the case where load data W_{2,t} at the time point t is not “0” in a portion of the formula (3) expressing the temperature and load of the storage (FPGA), this indicates that the load data W_{2,t} is to be offloaded at the time point t. Meanwhile, in the case where the load data W_{2,t} at the time point t is “0” in the portion of the formula (3) expressing the temperature and load of the storage (FPGA), this indicates that the load data W_{2,t} is not offloaded at the time point t. This case is the case where load data W_{1,t} at the time point t is not “0” in a portion expressing the temperature and load of the server (CPU).

[Example of Second Management Process]

The management apparatus 100 feeds back an effect of reduction of the calculation time by the scheduler 300 and an effect obtained by the offload, and recalculates the load distribution or the air conditioning control amounts to further reduce the power of the server room 10.

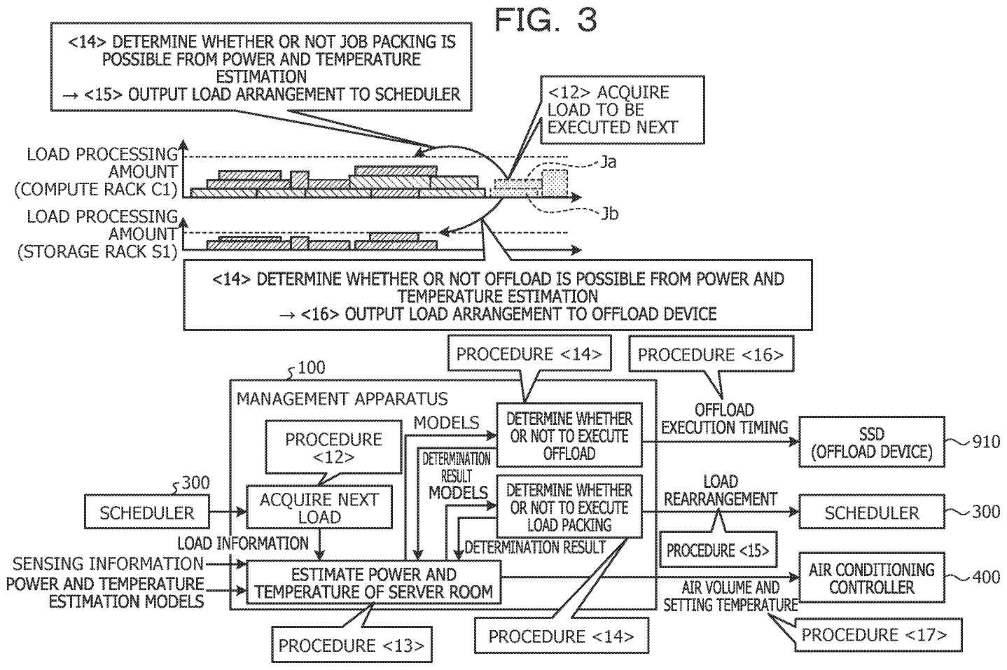

FIG. 3 is a diagram illustrating an example of a second management process according to the embodiment. As illustrated in FIG. 3, the management apparatus 100 acquires load information to be executed next from the scheduler 300 (<12>). If the management apparatus 100 is unable to acquire the load information to be executed next, the management apparatus 100 may estimate the load information by using a load estimation model. An example of the load estimation model will be described later.

The management apparatus 100 estimates the power distribution and temperature distribution of the server room 10 again from the load information to be executed next (<13>). For example, the management apparatus 100 receives the load information and estimates the power distribution and temperature distribution of the server room 10 in the case of the received load information based on the temperature estimation model and the power estimation model of the server room 10.

The management apparatus 100 determines whether or not the load packing or the offload packing is possible within the limitation conditions (<14>). For example, the management apparatus 100 estimates the new load distribution including the offload execution timing and the air conditioning control amounts (setting temperature and air volume), based on the power optimization model in addition to the power distribution and temperature distribution, such that the power of the server room 10 is minimized within the limitation conditions. As a result, an execution timing indicating the load packing or the offload packing is estimated for the load information to be executed next. The air conditioning control amounts (setting temperature and air volume) in the case of the new load distribution are also estimated. The power optimization model is the same as that in the formula (2). An example of the temperature estimation model will be described later. The term “load packing” herein refers to packing of loads into the CPU 810. The offload packing refers to packing of loads into the SSD 910 (FPGA) by offload. In the case where the load packing or the offload packing is possible, the management apparatus 100 determines whether or not further power reduction is possible by the load packing or the offload packing.

In the case where the load packing is possible, the management apparatus 100 outputs rearrangement of load to the scheduler 300 to pack the loads (<15>). In the case where the offload packing is possible, the management apparatus 100 outputs the offload execution timing to the SSD 910 that is an offload device (<16>). The management apparatus 100 outputs the air conditioning control amounts (setting temperature and air volume) estimated in <13> to the air conditioning controller 400 (<17>).

In this example, pieces of load information Ja and Jb to be executed next by the CPU 810 of the compute server mounted in the compute rack C1 are illustrated. The management apparatus 100 estimates the power distribution and temperature distribution of the server room 10 again from the load information to be executed next. The management apparatus 100 determines whether or not the offload packing or the load packing into the CPU 810 is possible within the limitation conditions. In this example, the management apparatus 100 determines that the load packing of the load information Ja into the CPU 810 is possible. Accordingly, the management apparatus 100 outputs the rearrangement of load to the scheduler 300. The management apparatus 100 determines that the offload packing of the load information Jb is possible. Accordingly, the management apparatus 100 outputs the load arrangement including the offload execution timing to the SSD 910 that is the offload device.

The load estimation model used in <12> will be described. The load estimation model is expressed by the following the formula (4).

$$= ( {x}_{1 , t - n} {U}_{1 , t - n} + … + {x}_{1 , t} {U}_{1 , t} ) + … + ( {x}_{p , t - n} {U}_{p , t - n} + … + {x}_{p , t} {U}_{p , t} ) + ( {y}_{1 , t - n} {J}_{1 , t - n} + … + {y}_{1 , t} {J}_{1 , t} ) + … + ( {y}_{q , t - n} {J}_{q , t - n} + … + {y}_{q , t} {J}_{q , t} ) \qquad ( 4 )$$

The load estimation model expressed by the formula (4) is a linear model for estimating a load amount to be inputted in the e-th step after the current step. Into the load estimation model, p types of user information U and q types of input load amounts J from the time point t−n to the time point t are inputted. The shape of the load to be executed next varies mainly depending on a user who executes the load. For example, in the case of a load (job) of a user A, the next job may be assumed to be a job relating to computation based on past loads of the user A. In the case of a load (job) of a user B, the next job may be assumed to be a job relating to writing of data based on past loads of the user B. Accordingly, the shape of the load to be executed next may be assumed based on the load estimation model using the user information.

The temperature estimation model used in the second management process will be described. The temperature estimation model used in the second management process is expressed by the following formula (5).

$$= ( {a}_{1 , t - n} {T}_{1 , t - n} + … + {a}_{1 , t} {T}_{1 , t} ) + … + ( {a}_{i , t - n} {T}_{i , t - n} + … + {a}_{i , t} {T}_{i , t} ) + ( {b}_{1 , t - n} {P}_{1 , t - n} + … + {b}_{1 , t} {P}_{1 , t} ) + … + ( {b}_{j , t - n} {P}_{j , t - n} + … + {b}_{j , t} {P}_{j , t} ) + ( {c}_{1 , t - n} {W}_{1 , t - n} + … + {c}_{1 , t} ( {W}_{1 , t} + ( {z}_{1 , 1 , 1} + … + {z}_{1 , e , 1} ) + … + ( {z}_{1 , 1 , q} + … + {z}_{1 , e , q} ) ) ) + … + ( {c}_{k , t - n} {W}_{k , t - n} + … + {c}_{k , t} ( {W}_{k , t} + ( {z}_{k , 1 , 1} + … + {z}_{k , e , 1} ) … + ( {z}_{k , 1 , q} + … + {z}_{k , e , q} ) ) ) + ( {d}_{1 , t - n} {S}_{1 , t - n} + … + {d}_{1 , t} {S}_{1 , t} ) + … + ( {d}_{i , t - n} {S}_{i , t - n} + … + {d}_{i , t} {S}_{i , t} ) + ( {e}_{1 , t - n} {F}_{1 , t - n} + … + {e}_{1 , t} {F}_{1 , t} ) + … + ( {e}_{i , t - n} {F}_{i , t - n} + … + {e}_{i , t} {F}_{i , t} ) \qquad ( 5 )$$

The temperature data measured by the i indoor temperature sensors and the power data measured by the j device power sensors in the server room 10 are inputted into the temperature estimation model expressed by the formula (5). The load amount from the time point t−n to the time point t that is a load amount inputted into each of the CPU 810 and SSD 910 and that is estimated in the first management process are also inputted. The load amounts from the time point t+1 to the time point t+e inputted in the second management process are also inputted. The number of steps for which the estimation is to be performed is determined based on the configuration of the server room 10 and the like. In this example, the temperature estimation model is a linear model for estimating temperature T in the next step. The temperature data T measured by each of the i indoor temperature sensors indicates a value of each of the indoor temperature sensors from a time point t−n to a time point t. The power data P measured by each of the j device power sensors indicates a value of each of the device power sensors from the time point t−n to the time point t. The total number of the compute servers and the storages is assumed to be j.

The k pieces of load amount data W at the time point t are unknown data. The e pieces of load amount data J from the time point t+1 to the time point t+e are the upcoming loads and are unknown data. The total number of the CPUs 810 and the SSDs 910 (FPGAs) capable of offload is assumed to be k. The l pieces of air conditioning setting temperature data S from the time point t−n to the time point t are unknown data. The l pieces of air conditioning air volume data F from the time point t−n to the time point t are unknown data. The total number of air conditioners is assumed to be l. Coefficients a, b, c, and d are determined respectively by model learning.

Since the power estimation model is a linear model similar to the formula (5), the formula of this model is omitted. In the power estimation model, the coefficients a, b, c, and d may be changed to those for power estimation. The coefficients a, b, c, and d are each determined by model learning.

The same model as that of the formula (2) is applied as the power optimization model.

The management apparatus 100 receives the load information and estimates the power distribution and temperature distribution of the server room 10 in the case of the received load information based on the temperature estimation model and the power estimation model as described above. The management apparatus 100 estimates the new load distribution including the offload execution timing and the air conditioning control amounts (setting temperature and air volume), based on the power optimization model in addition to the power distribution and temperature distribution, such that the power of the server room 10 is minimized within the limitation conditions. A term z_{k,e,q} of the temperature estimation model expressed by the formula (5) is a flag indicating whether or not an upcoming load J_{q,t+e} is to be executed at the time point t. In the case where z_{k,e,q} is “0”, this indicates that the upcoming load J_{q,t+e} is not executed. In the case where z_{k,e,q} is “1”, this indicates that the upcoming load J_{q,t+e} is to be executed. Accordingly, in the case where z_{k,e,q} of k corresponding to the CPU 810 is “1”, this means that the load packing into the CPU 810 is to be executed. In the case where z_{k,e,q} of k corresponding to the SSD 910 (FPGA) is “1”, this means that the offload packing into the SSD 910 (FPGA) is to be executed.

[Example of Functional Configuration of System Including Management Apparatus]

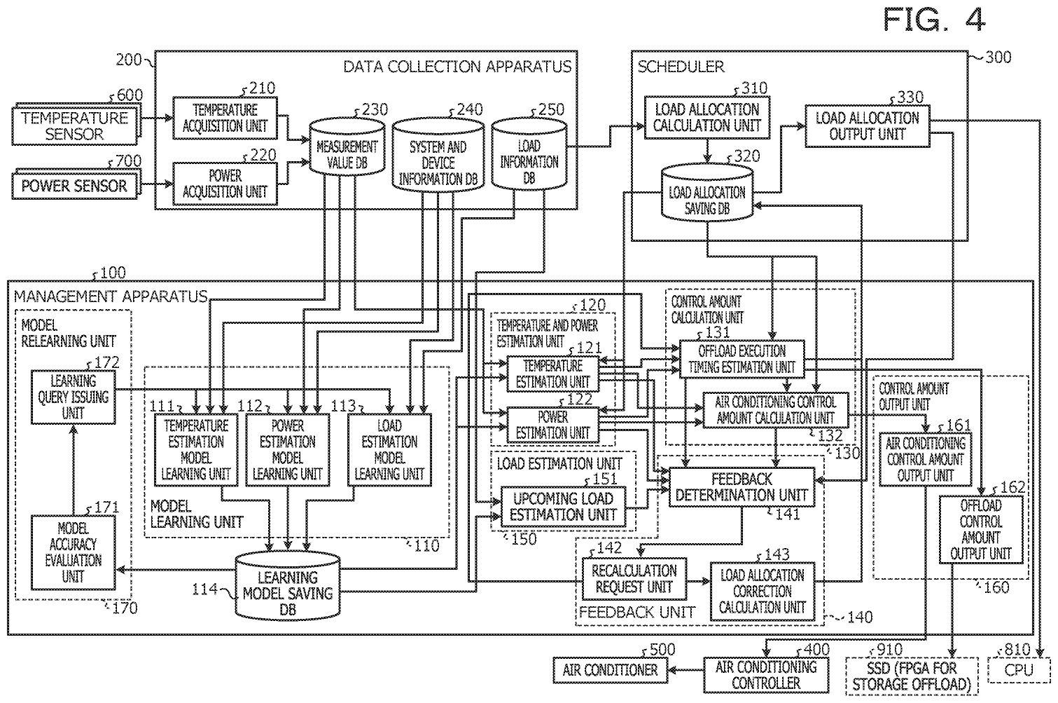

FIG. 4 is a diagram illustrating an example of a functional configuration of a system including the management apparatus according to the embodiment. As illustrated in FIG. 4, the system includes the management apparatus 100, a data collection apparatus 200, the scheduler 300, the air conditioning controller 400, the air conditioner 500, temperature sensors 600, and power sensors 700. The temperature sensors 600 are installed, for example, on back surfaces of the compute racks and the storage racks or in devices of the compute servers and the storage servers. The power sensors 700 are installed, for example, in the devices of the compute servers and the storage servers.

The data collection apparatus 200 collects data. The data collection apparatus 200 includes a temperature acquisition unit 210, a power acquisition unit 220, a measurement value database (DB) 230, a system and device information DB 240, and a load information DB 250.

The temperature acquisition unit 210 acquires temperature measurement values from the temperature sensors 600. The temperature acquisition unit 210 stores the acquired temperature measurement values in the measurement value DB 230 in association with identifiers identifying the temperature sensors 600. The power acquisition unit 220 acquires power measurement values from the power sensors 700. The power acquisition unit 220 stores the acquired power measurement values in the measurement value DB 230 in association with identifiers identifying the power sensors 700.

The measurement value DB 230 stores the temperature measurement values in association with the identifiers of the temperature sensors 600. The measurement value DB 230 stores the power measurement values in association with the identifiers of the power sensors 700.

The system and device information DB 240 stores a system configuration and a device configuration. For example, the system and device information DB 240 stores information on the server room in the system. The information on the server room includes the device configuration of the compute servers and the storage servers. The system and device information DB 240 is set in advance.

The load information DB 250 stores load information. User information of each load (job) is stored in the load information. For example, a type, a calculation amount, and the user information (user name, file name, file attribute, and the like) of the load (job) are stored in the load information at each time point. The user information includes p types of information on users. The load information DB 250 is set in advance.

The scheduler 300 distributes loads to each of the CPUs 810 in the respective compute servers. The scheduler 300 includes a load allocation calculation unit 310, a load allocation saving DB 320, and a load allocation output unit 330. When the load allocation calculation unit 310 receives loads, the load allocation calculation unit 310 calculates a load amount to be allocated to each CPU 810 and stores the load arrangement (load distribution) in the load allocation saving DB 320. The load allocation output unit 330 outputs the load amount allocated to each CPU 810, to the relevant CPU 810 based on the load arrangement stored in the load allocation saving DB 320.

The management apparatus 100 includes a model learning unit 110, a temperature and power estimation unit 120, a control amount calculation unit 130, a feedback unit 140, a load estimation unit 150, a control amount output unit 160, and a model relearning unit 170.

The model learning unit 110 includes a temperature estimation model learning unit 111, a power estimation model learning unit 112, a load estimation model learning unit 113, and a learning model saving DB 114. The temperature estimation model learning unit 111 generates the temperature estimation model from the measurement values and the system and device configurations. For example, the temperature estimation model learning unit 111 generates temperature estimation models of the formulae (1) and (5). The power estimation model learning unit 112 generates the power estimation model from the measurement values and the system and device configurations. For example, the power estimation model learning unit 112 generates a linear model similar to the formula (1) as the power estimation model. The load estimation model learning unit 113 generates the load estimation model. For example, the load estimation model learning unit 113 generates the load estimation model expressed by the formula (4). The learning model saving DB 114 saves each of various learning models. For example, the learning model saving DB 114 includes the power optimization model expressed by the formula (2) in addition to the temperature estimation model, the power estimation model, and the load estimation model.

The temperature and power estimation unit 120 includes a temperature estimation unit 121 and a power estimation unit 122. The temperature estimation unit 121 inputs the measurement values and the load distribution into the temperature estimation model and estimates the temperature distribution. The power estimation unit 122 inputs the measurement values and the load distribution into the power estimation model and estimates the power distribution. For example, in the temperature estimation model expressed by the formula (1), the temperature measurement values that are the measurement values correspond to values T_{i,t} of the i indoor temperature sensors from the time point t−n to the time point t. The power measurement values that are the measurement values correspond to values P_{j,t} of the j device power sensors from time point t−n to the time point t. The loads in the load distribution are assigned respectively to W_{1,t} to W_{k,t} such that the power is minimized in the power optimization model.

The control amount calculation unit 130 includes an offload execution timing estimation unit 131 and an air conditioning control amount calculation unit 132. The offload execution timing estimation unit 131 inputs the temperature distribution and the power distribution into the power optimization model and estimates the new load distribution including the offload execution timing. For example, the offload execution timing estimation unit 131 may estimate the new load distribution by using the temperature estimation model expressed by the formula (1), the power estimation model, and the power optimization model expressed by the formula (2).

The air conditioning control amount calculation unit 132 inputs the temperature distribution and the power distribution into the power optimization model and estimates the setting temperature and air volume as the air conditioning control amounts. For example, the air conditioning control amount calculation unit 132 estimates the setting temperature and air volume as the air conditioning control amounts by using the temperature estimation model expressed by the formula (1), the power estimation model, and the power optimization model expressed by the formula (2). For example, in the temperature estimation model expressed by the formula (1), the estimated new load distribution including the offload execution timing is set in W_{l,t} to W_{k,t}. The estimated setting temperature is set in each of S_{l,t} to S_{l,t}. The estimated air volume is set in each of F_{l,t} to F_{l,t}.

The feedback unit 140 includes a feedback determination unit 141, a recalculation request unit 142, and a load allocation correction calculation unit 143. The feedback determination unit 141 acquires the upcoming load, inputs the load distribution including the upcoming load into the temperature estimation model, and estimates the temperature distribution. The feedback determination unit 141 inputs the load distribution including the upcoming load into the power estimation model and estimates the power distribution. The feedback determination unit 141 inputs the temperature distribution and the power distribution into the power optimization model and estimates the new load distribution. For example, the feedback determination unit 141 may estimate the new load distribution by using the temperature estimation model expressed by the formula (5), the power estimation model, and the power optimization model expressed by the formula (2).

In the case where the load packing of the upcoming loads is determined to be possible from the new load distribution, the feedback determination unit 141 determines whether or not further power reduction is possible. In the case where the offload packing of the upcoming load is determined to be possible from the new load distribution, the feedback determination unit 141 determines whether or not further power reduction is possible. Whether or not further power reduction is possible may be determined by, for example, comparing the server room power in the formula (2) before the feedback with that after the feedback.

The recalculation request unit 142 outputs a recalculation query to the offload execution timing estimation unit 131 and requests recalculation of the offload execution timing in the case where the offload packing of the upcoming load is possible and further power reduction is possible.

The load allocation correction calculation unit 143 calculates the load amount to be packed in the case where the load packing of the upcoming load is possible and further power reduction is possible. The load allocation correction calculation unit 143 updates correction information of the load allocation for the load allocation saving DB 320.

The load estimation unit 150 includes an upcoming load estimation unit 151. The upcoming load estimation unit 151 estimates the upcoming load in the case where acquisition of the upcoming load is not possible. For example, the upcoming load estimation unit 151 estimates the upcoming load by using the load estimation model expressed by the formula (4). The p types of user information from the time point t−n to the time point t in the load estimation model may be acquired from the load information DB 250.

The control amount output unit 160 includes an air conditioning control amount output unit 161 and an offload control amount output unit 162. The air conditioning control amount output unit 161 outputs the air conditioning control amounts to the air conditioning controller 400. For example, the air conditioning control amount output unit 161 outputs the air conditioning control amounts (setting temperature and air volume) calculated by the air conditioning control amount calculation unit 132 to the air conditioning controller 400. The air conditioning controller 400 then outputs the air conditioning control amounts (setting temperature and air volume) to the air conditioner 500. The offload control amount output unit 162 outputs an offload control amount to the SSD 910 representing the FPGA for offload in the storage. For example, when W_{k,t} that is estimated by the offload execution timing estimation unit 131 and that corresponds to the FPGA for offload is not “0”, the offload control amount output unit 162 outputs W_{k,t} in this case to the corresponding SSD 910 representing the FPGA for offload, as the load amount.

The model relearning unit 170 includes a model accuracy evaluation unit 171 and a learning query issuing unit 172. The model accuracy evaluation unit 171 compares current estimation results using the models with past estimation results, and evaluates the accuracy of the models. The models herein refer to the temperature estimation model, the power estimation model, and the load estimation model. In the case where the model accuracy evaluation unit 171 determines that the accuracy of the models is poor, the learning query issuing unit 172 issues a query for generating models for the next time.

[Flowchart of Data Collection Process]

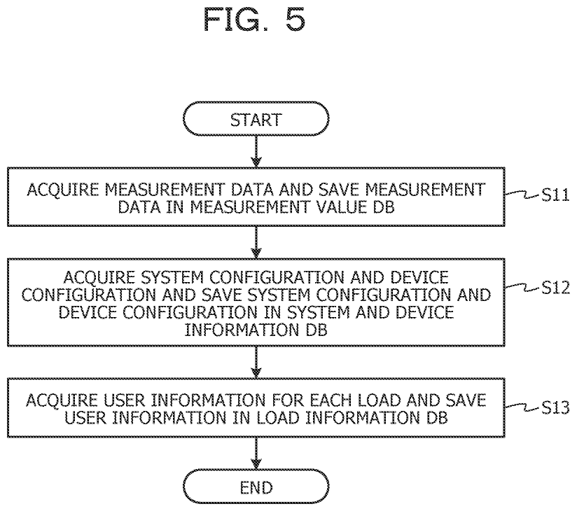

FIG. 5 is a diagram illustrating an example of a flowchart of a data collection process according to the embodiment with reference to FIG. 4. As illustrated in FIG. 5, the data collection apparatus 200 acquires the measurement data of temperature and power and saves the measurement data in the measurement value DB 230 (step S11). The data collection apparatus 200 acquires the system configuration and the device configuration and saves the system configuration and the device configuration in the system and device information DB 240 (step S12). The data collection apparatus 200 acquires the user information of each load and saves the user information in the load information DB 250 (step S13).

[Flowchart of Scheduler Process]

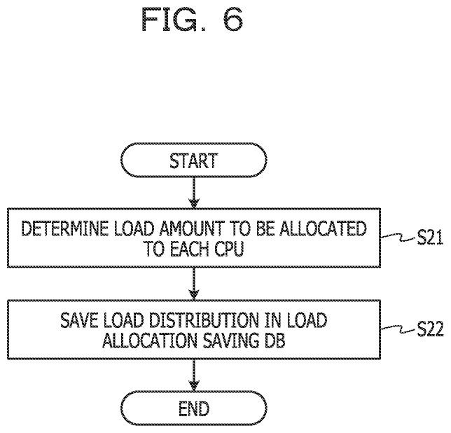

FIG. 6 is a diagram illustrating an example of a flowchart of a scheduler process according to the embodiment with reference to FIG. 4. As illustrated in FIG. 6, the scheduler 300 determines the load amount to be allocated to each CPU 810 (step S21). The scheduler 300 saves the load distribution (load allocation) in the load allocation saving DB 320 (step S22).

[Flowchart of Process of Management Apparatus]

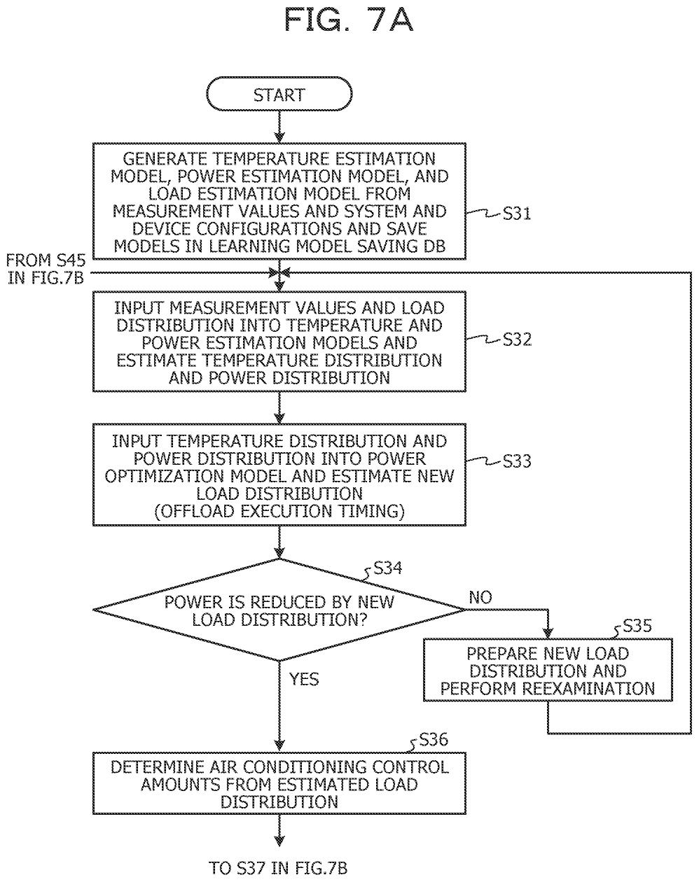

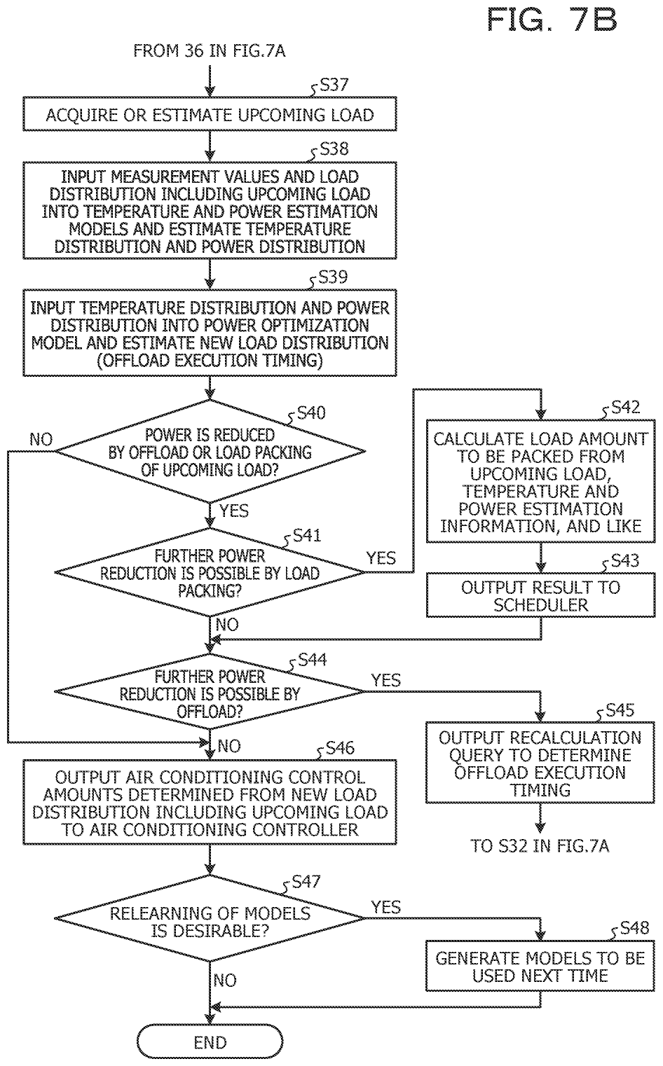

FIGS. 7A and 7B are each a diagram illustrating an example of a flowchart of a process in the management apparatus according to the embodiment with reference to FIG. 4. FIG. 7A illustrates an example of a flowchart of the first management process in the management apparatus according to the embodiment. As illustrated in FIG. 7A, the model learning unit 110 generates the temperature estimation model, the power estimation model, and the load estimation model by using the measurement values and the system and device configurations, and saves the models in the learning model saving DB 114 (step S31).

The temperature and power estimation unit 120 inputs the measurement values and the load distribution into the temperature estimation model (see formula (1)) and the power estimation model, and estimates the temperature distribution and the power distribution (step S32). The control amount calculation unit 130 inputs the temperature distribution and the power distribution into the power optimization model (see formula (2)), and estimates the new load distribution including the offload execution timing (step S33). The control amount calculation unit 130 determines whether or not the power is reduced by the new load distribution (step S34). For example, the control amount calculation unit 130 uses the server room power of the power optimization model (2) to compare the power before the estimation of the new load distribution with that after the estimation. In the case where the power after the estimation of the new load distribution is smaller than the power before the estimation, the control amount calculation unit 130 determines that the power is reduced by the new load distribution. In the case where the power after the estimation of the new load distribution is equal to or greater than the power before the estimation, the control amount calculation unit 130 determines that the power is not reduced by the new load distribution.

In the case where the control amount calculation unit 130 determines that the power is not reduced by the new load distribution (step S34; No), the control amount calculation unit 130 prepares a new load distribution for reexamination (step S35) and proceeds to step S32.

Meanwhile, in the case where the control amount calculation unit 130 determines that the power is reduced by the new load distribution (step S34; Yes), the control amount calculation unit 130 determines the air conditioning control amounts from the estimated new load distribution (step S36). For example, the control amount calculation unit 130 determines, as the air conditioning control amounts, the setting temperature and air volume set when the temperature distribution and the power distribution are inputted into the power optimization model and the new load distribution including the offload execution timing is estimated. The control amount calculation unit 130 then terminates the first management process.

FIG. 7B illustrates an example of a flowchart of the second management process in the management apparatus according to the embodiment. As illustrated in FIG. 7B, the feedback unit 140 acquires or estimates the upcoming load (step S37). For example, in the case where the feedback unit 140 is unable to acquire the upcoming load, the feedback unit 140 may cause the load estimation unit 150 to estimate the upcoming load.

The feedback unit 140 inputs the measurement values and the load distribution into the temperature estimation model (see formula (5)) and the power estimation model to estimate the temperature distribution and the power distribution (step S38). The feedback unit 140 inputs the temperature distribution and the power distribution into the power optimization model (see formula (2)) to estimate the new load distribution including the offload execution timing (step S39). The feedback unit 140 determines whether or not the power is reduced (energy saving is possible) by the load packing or offload of the upcoming load (step S40).

In the case where the feedback unit 140 determines that power is not reduced by the load packing or offload of the upcoming load (step S40; No), the feedback unit 140 proceeds to step S46. Meanwhile, in the case where the feedback unit 140 determines that power is reduced (power saving is possible) by the load packing or offload of the upcoming load (step S40; Yes), the feedback unit 140 determines whether or not further power reduction is possible by the load packing (step S41). In the case where the feedback unit 140 determines that further power reduction is not possible by the load packing (step S41; No), the feedback unit 140 proceeds to step S44.

Meanwhile, in the case where the feedback unit 140 determines that further power reduction is possible by the load packing (step S41; Yes), the feedback unit 140 calculates a load amount to be packed, from the upcoming load, temperature and power estimation information, and the like (step S42). For example, the feedback unit 140 may refer to J_{q,t+e} corresponding to the CPU 810 in the formula (5) as the load amount to be packed. The feedback unit 140 outputs the result to the scheduler 300 (step S43). The scheduler 300 updates data in the load allocation saving DB 320 to the outputted result. The feedback unit 140 then proceeds to step S44.

In step S44, the feedback unit 140 determines whether or not further power reduction is possible by the offload (step S44). In the case where the feedback unit 140 determines that further power reduction is not possible by the offload (step S44; No), the feedback unit 140 proceeds to step S46. Meanwhile, in the case where the feedback unit 140 determines that further power reduction is possible by the offload (step S44; Yes), the feedback unit 140 outputs the recalculation query to the control amount calculation unit 130 to determine the offload execution timing (step S45). The feedback unit 140 then proceeds to step S32 in FIG. 7A.

In step S46, the control amount calculation unit 130 determines the air conditioning control amounts from the new load distribution including the estimated upcoming load, and outputs the determined air conditioning control amounts to the air conditioning controller 400 (step S46). For example, the control amount calculation unit 130 determines, as the air conditioning control amounts, the setting temperature and air volume set when the temperature distribution and the power distribution are inputted into the power optimization model and the new load distribution including the offload execution timing is estimated. The control amount calculation unit 130 outputs the determined air conditioning control amounts to the air conditioning controller 400.

The model relearning unit 170 determines whether or not relearning of the models is desirable (step S47). For example, the model relearning unit 170 compares the current estimation result with the past estimation result. The model relearning unit 170 determines whether or not relearning of the models is desirable based on the comparison result. In the case where the model relearning unit 170 determines that relearning of the models is desirable (step S47; Yes), the model relearning unit 170 generates models to be used next time (step S48). The model relearning unit 170 then terminates the second management process.

Meanwhile, in the case where the model relearning unit 170 determines that relearning of the models is not desirable (step S47; No), the model relearning unit 170 terminates the second management process.

According to the embodiment, the temperature estimation model and the power estimation model are described as the linear models for estimating temperature and power in the next step. However, the temperature estimation model and the power estimation model are not limited to the linear models and may be non-linear models. For example, temperature and power in the next step may be estimated by using deep learning. Similarly, the load estimation model is described as the linear model for estimating the load to be inputted in the e-th step after the current step. However, the load estimation model is not limited to the linear model and may be a nonlinear model. For example, the load to be inputted in the e-th step after the current step may be estimated by using deep learning.

### Effects of Embodiment

According to the above-described embodiment, the management apparatus 100 receives the load arrangement of the jobs in the case where the compute servers mounted in the compute racks in the server room execute the jobs, the server room being a room where the compute racks in which the compute servers are mounted and the storage racks in which the storages are mounted are arranged. The management apparatus 100 estimates the time at which a predetermined job of the compute server is to be offloaded to the storage that generates less heat than the compute server, and estimates the setting temperature and air volume of the air conditioner, based on the received load arrangement of the jobs and the time-series data of the temperature and power of the server room, such that the power of the server room is minimized within the limitation conditions of the compute servers, the storages, and the air conditioner. According to such a configuration, the management apparatus 100 may reduce temperature unevenness between the compute racks and the storage racks and suppress the setting temperature and air volume of the air conditioner by offloading the predetermined job of the compute server to the storage that generates less heat than the compute server.

According to the above-described embodiment, the management apparatus 100 estimates the setting temperature and air volume of the air conditioner and the time at which the predetermined job of the compute server is to be offloaded to the storage based on the predetermined models in which the load arrangement of the jobs and the time-series data of the temperature and the power of the compute servers and the storages included in the server room are inputted and that output the setting temperature, the air volume, and the execution timing of each of the jobs forming the load arrangement in the compute server or the storage. According to such a configuration, the management apparatus 100 may reduce temperature unevenness between the compute racks and the storage racks and suppress the setting temperature and air volume of the air conditioner by using the predetermined models.

According to the above-described embodiment, the management apparatus 100 further receives a load of a predetermined job to be executed next by the compute server. The management apparatus 100 estimates whether or not the packing of the job into the compute server is possible and whether or not there is a time to offload the job to the storage, based on the received load of the job. According to such a configuration, the management apparatus 100 may reduce the entire calculation time for the jobs by packing the next job into an unused processing capacity of the storage or an unused processing capacity of the compute server in which a spare processing capacity is generated by the offload.

According to the above-described embodiment, in the case where the management apparatus 100 estimates that there is a time to offload the job to the storage, the management apparatus 100 determines whether or not power reduction is possible. According to such a configuration, the management apparatus 100 may achieve further power reduction.

According to the above-described embodiment, in the case where the management apparatus 100 estimates that the packing of the job into the compute server is possible, the management apparatus 100 determines whether or not power reduction is possible. According to such a configuration, the management apparatus 100 may achieve further power reduction.

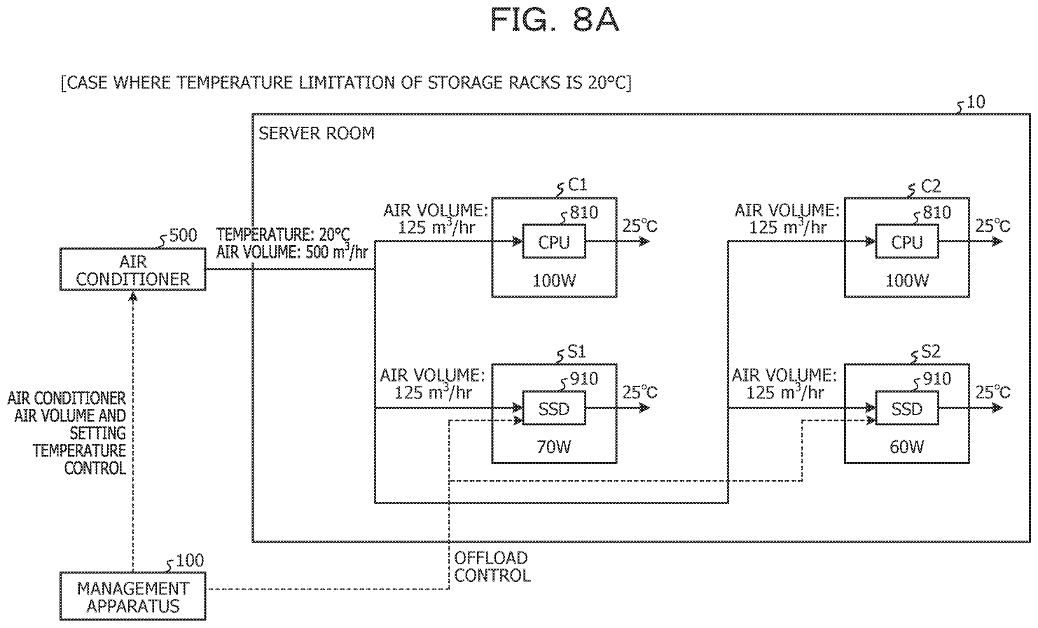

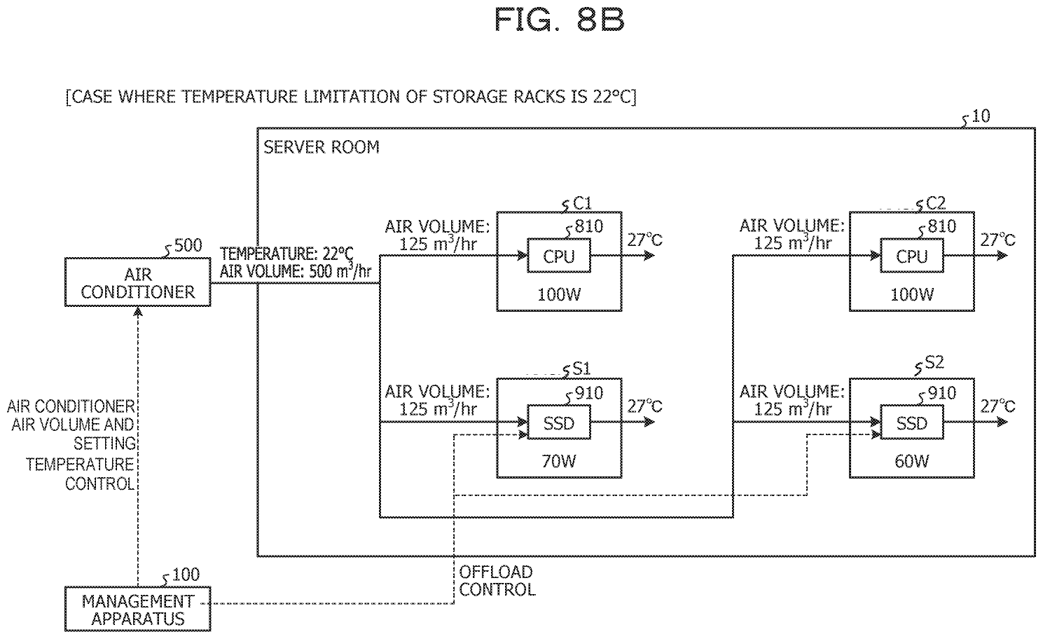

Effects of the processes performed by the management apparatus 100 according to the embodiment will be described with reference to FIGS. 8A and 8B. FIGS. 8A and 8B are diagrams illustrating the effects of the processes by the management apparatus according to the embodiment. First, as illustrated in FIG. 10 as a reference example, the loads of the compute racks C1 and C2 vary from each other. Assume that, in the air conditioner 500, the setting temperature is 20° C. and the air volume is 1000 m³/hr and the storage rack S1 and the compute rack C2 are in an excessively cooled state.

FIG. 8A illustrates the case where the temperature limitation of the storage racks is 20° C. in addition to the same conditions. In such a case, the management apparatus 100 performs offload control to offload predetermined jobs of the CPUs 810 to the respective SSDs 910 in the storage racks S1 and S2. In the air conditioner 500 that has received the setting temperature and air volume controlled by the management apparatus 100, the setting temperature is 20° C. and the air volume is 500 m³/hr. Since reduction of the air volume in the compute rack C1 and the storage rack S2 is possible, the excessive cooling may be mitigated. Assuming that a desired air volume is a temperature difference of 10° C., the desired air volume of the air conditioner is halved and the power for cooling is reduced by 8.8% (=( 1/10)×(1−(½)³)×100).

FIG. 8B illustrates the case where the temperature limitation of the storage racks is 22° C. in addition to the same conditions. In such a case, the management apparatus 100 performs offload control to offload predetermined jobs of the CPUs 810 to the respective SSDs 910 in the storage racks S1 and S2. In the air conditioner 500 that has received the setting temperature and air volume controlled by the management apparatus 100, the setting temperature may be set higher than that in the case of FIG. 8A and the setting temperature is 22° C. and the air volume is 500 m³/hr. The setting temperature may be thus increased by 2° C. and the power for cooling is reduced by 14.4% (power is assumed to be reduced by about 8% per increase of 1° C. of the setting temperature). Together with the case of FIG. 8A, the power for cooling is reduced by 23.2% (=8.8+14.4).

[Others]

The processing procedures, control procedures, specific names, and information including various types of data and parameters described in the above document and drawings may be arbitrarily changed unless otherwise noted.

Each of the illustrated elements of each of the devices is a functional concept and does not have to be physically configured as illustrated. For example, specific forms of distribution and integration of each of the devices are not limited to those illustrated. For example, all or some of the devices may be configured to be functionally or physically distributed or integrated in an arbitrary unit(s) depending on various types of loads, usage conditions, and the like. For example, the management apparatus 100 may be configured such that the data collection apparatus 200 is integrated therein.

Entire portions or arbitrary portions of each of the processing functions performed in each of the devices may be implemented by a CPU and a program analyzed and executed by the CPU or by hardware using wired logic.

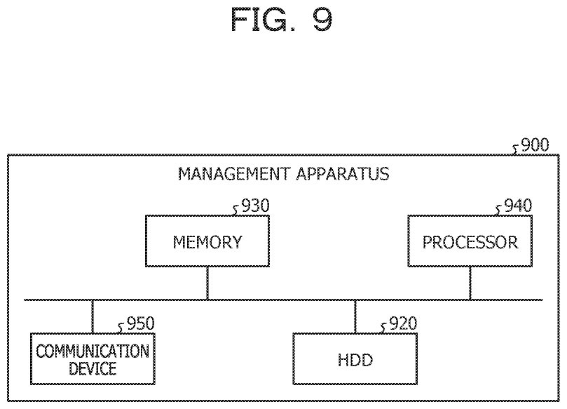

FIG. 9 is a diagram illustrating a hardware configuration example of a management apparatus 900. As illustrated in FIG. 9, the management apparatus 900 is an information processing apparatus including a communication device 950, a hard disk drive (HDD) 920, a memory 930, and a processor 940. The respective units illustrated in FIG. 9 are coupled to one another by a bus or the like.

The communication device 950 is a network interface card or the like and communicates with another apparatus. The HDD 920 stores a program and a database (DB) that are used to cause the functions illustrated in FIG. 4 to operate.

The processor 940 runs process of executing the respective functions described in FIG. 4 and the like by reading a program, configured to execute processes similar to those of the respective processing units illustrated in FIG. 4, from the HDD 920 or the like and loading the program into the memory 930. For example, in this process, functions similar to those of the respective processing units included in the management apparatus 100 are executed. For example, the processor 940 reads, from the HDD 920 or the like, a program having functions similar to those of the model learning unit 110, the temperature and power estimation unit 120, the control amount calculation unit 130, the feedback unit 140, the load estimation unit 150, the control amount output unit 160, the model relearning unit 170, and the like. The processor 940 executes process of executing the same processes as those of the model learning unit 110, the temperature and power estimation unit 120, the control amount calculation unit 130, the feedback unit 140, the load estimation unit 150, the control amount output unit 160, the model relearning unit 170, and the like.

As described above, the management apparatus 900 operates as an information processing apparatus that performs the management method by reading and executing the program. The management apparatus 900 may also achieve similar functions as those in the aforementioned embodiment by reading the aforementioned program from a recording medium with a medium reading device and executing the aforementioned read program. The program referred to in this other embodiment is not limited to that executed by the management apparatus 900. For example, the present disclosure may be similarly applied to the case where another computer or a server executes the program or the case where the other computer and the server execute the program in cooperation with each other.

The program may be distributed via a network such as the Internet. This program may be recorded on a computer-readable recording medium such as a hard disk, a flexible disk (FD), a compact disc read-only memory (CD-ROM), a magneto-optical (MO) disk, or a Digital Versatile Disc (DVD) and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a management program that causes a computer to execute a process, the process comprising:
receiving load arrangement of jobs in a case where a compute server mounted in a compute rack in a server room executes the jobs, the server room being a room where the compute rack in which the compute server is mounted and a storage rack in which a storage is mounted are arranged; and
estimating a time at which a predetermined job of the compute server is to be offloaded to the storage that generates less heat than the compute server and estimating setting temperature and an air volume of an air conditioner, based on the received load arrangement of the jobs and time-series data of temperature and power of the server room, such that the power of the server room is reduced within limitation conditions of the compute server, the storage, and the air conditioner.

2. The non-transitory computer-readable recording medium according to claim 1, the process further comprising:
estimating the setting temperature and air volume of the air conditioner and estimating the time at which the predetermined job of the compute server is to be offloaded to the storage based on a predetermined model in which the load arrangement of the jobs and time-series data of temperature and power of the compute server and the storage included in the server room are inputted and that outputs the setting temperature, the air volume, and an execution time of each of the jobs that form the load arrangement and executed in the compute server or the storage.

3. The non-transitory computer-readable recording medium according to claim 1, the process further comprising:
receiving a load of an upcoming job to be executed next by the compute server; and
estimating whether or not packing of the upcoming job into the compute server is possible and whether or not there is a time to offload the upcoming job to the storage, based on the received load of the upcoming job.

4. The non-transitory computer-readable recording medium according to claim 3, the process further comprising:
determining, in a case where it is estimated that there is the time to offload the upcoming job to the storage, whether or not power reduction is possible.

5. The non-transitory computer-readable recording medium according to claim 3, the process further comprising:
determining, in a case where it is estimated that the packing of the upcoming job into the compute server is possible, whether or not power reduction is possible.

6. The non-transitory computer-readable recording medium according to claim 1, wherein
the limitation conditions are such that temperature and power in each of the compute server and the storage are equal to or lower than respective predetermined limitation values.

7. An information processing apparatus, comprising:
a memory; and
a processor coupled to the memory and the processor configured to:
receive load arrangement of jobs in a case where a compute server mounted in a compute rack in a server room executes the jobs, the server room being a room where the compute rack in which the compute server is mounted and a storage rack in which a storage is mounted are arranged; and
estimate a time at which a predetermined job of the compute server is to be offloaded to the storage that generates less heat than the compute server and estimating setting temperature and an air volume of an air conditioner, based on the received load arrangement of the jobs and time-series data of temperature and power of the server room, such that the power of the server room is reduced within limitation conditions of the compute server, the storage, and the air conditioner.

8. A management method, comprising:
receiving, by a computer, load arrangement of jobs in a case where a compute server mounted in a compute rack in a server room executes the jobs, the server room being a room where the compute rack in which the compute server is mounted and a storage rack in which a storage is mounted are arranged; and
estimating a time at which a predetermined job of the compute server is to be offloaded to the storage that generates less heat than the compute server and estimating setting temperature and an air volume of an air conditioner, based on the received load arrangement of the jobs and time-series data of temperature and power of the server room, such that the power of the server room is reduced within limitation conditions of the compute server, the storage, and the air conditioner.
